(19) United States
(12) Patent Application Publication
(10) Pub. No.: US 2020/0096384 A1
(43) Pub. Date: Mar. 26, 2020

(54) BLADE ABNORMALITY DETECTING DEVICE, BLADE ABNORMALITY DETECTING SYSTEM, ROTARY MACHINE SYSTEM, AND BLADE ABNORMALITY DETECTING METHOD

(71) Applicant: MITSUBISHI HEAVY INDUSTRIES, LTD., Tokyo (JP)

(72) Inventors: Satoshi Saburi, Tokyo (JP); Akihiro Nakaniwa, Tokyo (JP); Takashi Sato, Tokyo (JP)

(73) Assignee: MITSUBISHI HEAVY INDUSTRIES, LTD., Tokyo (JP)

(21) Appl. No.: 16/495,493

(22) PCT Filed: Mar. 20, 2018
(86) PCT No.: PCT/JP2018/011026

§ 371 Date: Sep. 19, 2019

(30) Foreign Application Priority Data
Mar. 28, 2017 (JP) 2017-063267

(51) Int. Cl. G01H 1/00; G01M 7/02; F01D 21/00

(52) U.S. Cl. CPC G01H 1/006; F01D 21/003; G01M 7/025

(57) ABSTRACT

A blade abnormality detecting device has a vibration acquisition unit that acquires vibration of a steam turbine when a rotation speed of a rotor changes, along with the rotation speed, a frequency analysis unit that performs frequency analysis according to an acquisition result of the vibration acquisition unit, and acquires natural frequency in each rotation speed of a rotor blade row, a contact rotation speed acquisition unit that acquires a contact rotation speed, which serves as a boundary between a state where shrouds of neighboring rotor blades are in contact with each other and a state where the shrouds are spaced apart from each other, according to an analysis result of the frequency analysis unit, and a determination unit that determines whether or not the rotor blade row is abnormal according to the contact rotation speed acquired by the contact rotation speed acquisition unit.

### TECHNICAL FIELD

The present invention relates to a blade abnormality detecting device, a blade abnormality detecting system, a rotary machine system, and a blade abnormality detecting method.

Priority is claimed on Japanese Patent Application No. 2017-063267, filed on Mar. 28, 2017, the content of which is incorporated herein by reference.

### BACKGROUND ART

A rotary machine, for example, a steam turbine and a gas turbine, has a rotary shaft and a rotor blade row group formed of a plurality of rotor blade rows provided on an outer circumference of the rotary shaft. At the time of operation of the rotary machine, vibration of the rotating rotor blade rows is measured. By performing such measurement, whether or not vibration characteristics of the rotor blade rows are in accordance with a design plan can be verified. In addition, a change in vibration characteristics of rotor blades caused by a change in operation conditions can be checked, and thus improvement of reliability of a turbine product can be achieved.

For example, a technique of providing a displacement sensor in a stationary portion that is not in contact with a rotor blade and monitoring vibration of the rotor blade by means of the displacement sensor is disclosed in Patent Document 1.

In particular, at a low-pressure stage where the height of the rotor blade is large, a non-contact monitor that measures passing time of each rotor blade from a stationary side, and calculates the result to calculate a vibration form and a vibration amount of the rotor blade is applied in many cases.

In addition, a technique of providing a vibration detection unit in a stationary portion that slidably comes into contact with a rotor is disclosed in Patent Document 2. For example, by mounting a bearing box in an accelerometer, which is the vibration detection unit, vibration from a blade row group transmitted to the bearing box is detected by accelerometer.

### CITATION LIST

### Patent Literature

[Patent Document 1] Japanese Unexamined Patent Application, First Publication No. 2003-177059

[Patent Document 2] Japanese Unexamined Patent Application, First Publication No. S53-28806

### DISCLOSURE OF INVENTION

### Technical Problem

However, in the technique disclosed in Patent Document 1, at a high-pressure stage where the height of the rotor blade is small in particular, a mounting environment for the displacement sensor is poor, and a vibration amplitude of the rotor blade is low. Thus, vibration cannot be appropriately monitored. In addition, depending on properties of a working fluid such as steam and a combustion gas, an error occurs in a value detected by the displacement sensor, and vibration cannot be appropriately detected in some cases.

In addition, in the technique disclosed in Patent Document 2, it is necessary to go through vibration damping elements including a bearing oil film, a bearing, and a bearing housing in order to transmit vibration from a rotor blade row group to the bearing box. For this reason, the quality of a signal degrades, and a possibility of masking the signal due to background vibration is high. Thus, it is difficult to easily detect an abnormality in a rotor blade row with any of the techniques.

An object of the present invention is to provide a blade abnormality detecting device, a blade abnormality detecting system, a rotary machine system, and a blade abnormality detecting method, in which an abnormality of a rotor blade row can be easily detected.

### Solution to Problem

According to a first aspect of the present invention, there is provided a blade abnormality detecting device of a rotary machine including a rotor that has a rotary shaft that is configured to rotate about an axis and a rotor blade row formed of a plurality of rotor blades, which radially extend from the rotary shaft and have shrouds on tips. The blade abnormality detecting device includes a vibration acquisition unit that is configured to acquire vibration of the rotary machine when a rotation speed of the rotor changes, along with the rotation speed, a frequency analysis unit that is configured to perform frequency analysis according to an acquisition result of the vibration acquisition unit, and acquires natural frequency in each rotation speed of the rotor blade row, a contact rotation speed acquisition unit that is configured to acquire a contact rotation speed, which serves as a boundary between a state where the shrouds of the neighboring rotor blades are in contact with each other and a state where the shrouds of the neighboring rotor blades are spaced apart from each other, according to an analysis result of the frequency analysis unit, and a determination unit that determines whether or not the rotor blade row is abnormal according to the contact rotation speed acquired by the contact rotation speed acquisition unit.

In a state where the rotation speed of the rotor is low, the shrouds of the neighboring rotor blades are disposed at a gap. When the rotation speed of the rotor increases and becomes a certain degree of rotation speed, the shrouds of the neighboring rotor blades come into contact with each other in a circumferential direction. When the shrouds of the rotor blades come into contact with each other in this manner, the entire rotor blade row comes into an annularly connected state, and natural frequency of the entire rotor blade row increases. That is, the natural frequency of the rotor blade row rapidly increases until reaching the contact rotation speed that is a rotation speed at which the shrouds come into contact with each other. Similarly, also when the rotation speed of the rotor decreases, the shrouds which are in contact with each other space apart from each other until reaching the contact rotation speed, and the natural frequency of the entire rotor blade row rapidly declines.

In the aspect, by the frequency analysis unit performing frequency analysis according to actual vibration of the rotary machine and the rotation speed, which are acquired by the vibration acquisition unit, the natural frequency of the rotor blade row in each rotation speed is acquired. The contact rotation speed acquisition unit acquires, for example, a rotation speed at which the natural frequency of the rotor blades changes to a value that is equal to or higher than a threshold as the contact rotation speed. The rotation speed, at which a ratio of a change in natural frequency when the rotation speed is changed has become equal to or larger than the threshold, may be set as the contact rotation speed.

Herein, in a case where a contact surface is scraped in some cases due to friction caused by slight vibration between the shrouds and a gap between the neighboring shrouds widens accordingly as one form of an abnormality in the rotor blades, the contact rotation speed of the rotor blades increases compared to a normal state. Therefore, as natural frequency at the time of a rotation increase is observed, the contact rotation speed between the shrouds increases in an abnormal state caused by the shrouds being scraped, compared to normal times.

With this knowledge, the determination unit determines whether or not the rotor blade row is abnormal, that is, whether or not an abnormality has occurred in the rotor blades included in the rotor blade row according to an acquired value of the contact rotation speed. Therefore, an abnormality in the rotor blade row can be easily detected.

According to a second aspect of the present invention, there is provided a blade abnormality detecting system including the blade abnormality detecting device and a vibration sensor that is provided in the rotary machine and is configured to detect vibration of the rotary machine.

Accordingly, as described above, an abnormality in the rotor blade row can be easily detected.

In the blade abnormality detecting system, the rotary machine may have a bearing that supports the rotary shaft to be rotatable about the axis and a bearing stand that supports the bearing, and the vibration sensor may be an acceleration sensor provided in the bearing stand.

Consequently, even without providing a sensor inside the rotary machine, an abnormality in the rotor blade row can be easily detected.

According to a third aspect of the present invention, there is provided a rotary machine system including the rotary machine and the blade abnormality detecting system according to any description above.

According to a fourth aspect of the present invention, there is provided a blade abnormality detecting method of a rotary machine including a rotor that has a rotary shaft that is configured to rotate about an axis and a rotor blade row having a plurality of rotor blades, which radially extend from the rotary shaft. The blade abnormality detecting method includes a vibration acquisition step of acquiring vibration of the rotary machine along with a rotation speed of the rotor while changing the rotation speed, a frequency analysis step of performing frequency analysis according to an acquisition result of the vibration acquisition step and acquiring a relationship between the rotation speed and frequency, a contact rotation speed acquisition step of acquiring a contact rotation speed, which serves as a boundary between a state where shrouds of the neighboring rotor blades are in contact with each other and a state where the shrouds of the neighboring rotor blades are spaced apart from each other, according to an analysis result of the frequency analysis step, and a determination step of determining whether or not the rotor blade row is abnormal according to the contact rotation speed acquired in the contact rotation speed acquisition step.

### Advantageous Effects of Invention

In the blade abnormality detecting device, the blade abnormality detecting system, the rotary machine system, and the blade abnormality detecting method of the present invention, an abnormality in the rotor blades can be easily detected.

### BRIEF DESCRIPTION OF DRAWINGS

FIG. 1 is a schematic longitudinal sectional view of a steam turbine system (rotary machine system) according to a first embodiment.

FIG. 2 is a diagram showing a hardware configuration of a blade abnormality detecting device main body in a blade abnormality detecting device according to the first embodiment.

FIG. 3 is a functional block diagram of the blade abnormality detecting device main body in the blade abnormality detecting device according to the first embodiment.

FIG. 4 is a schematic view illustrating a non-contact state of shrouds of rotor blades of a rotor blade row.

FIG. 5 is a schematic view illustrating a state where the shrouds of the rotor blades of the rotor blade row are in contact with each other.

FIG. 6 is a Campbell diagram of the steam turbine system (rotary machine system) according to the first embodiment.

FIG. 7 is a flowchart showing procedures of a blade abnormality detecting method according to the first embodiment.

### BEST MODE FOR CARRYING OUT THE INVENTION

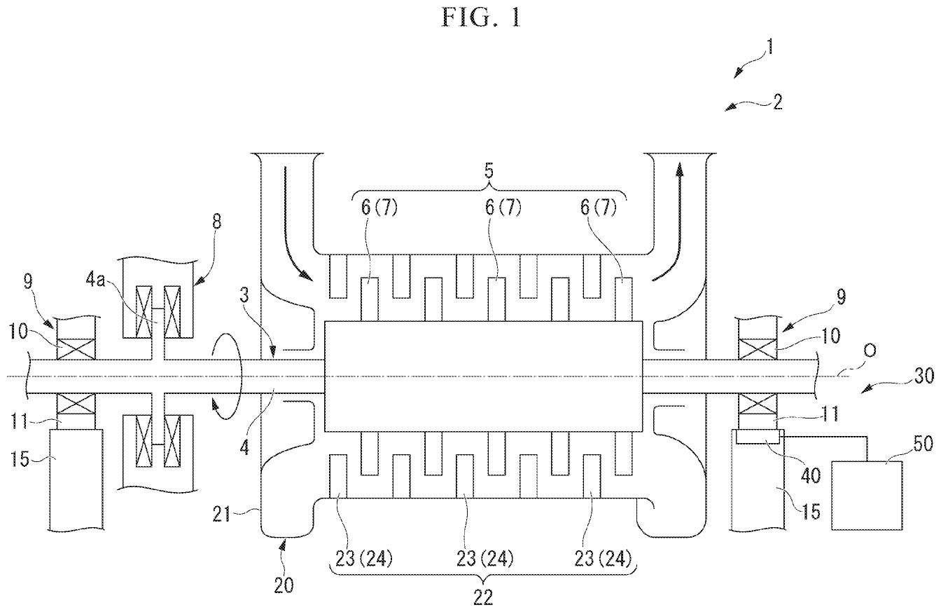

Hereinafter, a steam turbine system (rotary machine system) according to an embodiment of the present invention will be described with reference to FIGS. 1 to 7.

As illustrated in FIG. 1, a steam turbine system 1 includes a steam turbine 2 (rotary machine) and a blade abnormality detecting system 30.

The steam turbine 2 is an external combustion engine that produces steam energy as rotational power, and is used in a generator of a power plant. The steam turbine 2 includes a rotor 3, a thrust bearing 8, journal bearings 9 (bearings), bearing stands 15, and a stator 20.

The rotor 3 includes a rotary shaft 4 and a rotor blade row group 5.

The rotary shaft 4 has a cylindrical shape which extends with an axis O along a horizontal direction as a center. In a part of the rotary shaft 4, a thrust collar 4a is formed. The thrust collar 4a has a disk shape with the axis O as a center. The thrust collar 4a integrally protrudes from a main body of the rotary shaft 4 to a radially outer side of the rotary shaft 4 such that the thrust collar has a flange shape.

The rotor blade row group 5 is configured with a plurality of rotor blade rows 6 provided on an outer circumference of the rotary shaft 4 at intervals in an axis O direction. Each of the rotor blade rows 6 is configured by arranging a plurality of rotor blades 7 at intervals in a circumferential direction. The rotor blades 7 extend from an outer circumferential surface of the rotary shaft 4 to the radially outer side. That is, each of the rotor blade rows 6 is configured with the plurality of rotor blades 7 radially provided at positions in the same axis O direction of the rotary shaft 4.

The thrust bearing 8 slidably supports the thrust collar 4a from both sides of the axis O direction. Accordingly, the movement of the rotary shaft 4 in the axis O direction is regulated.

A pair of journal bearings 9 is provided on both end sides of the rotary shaft 4 such that the rotary shaft 4 is supported from below to be rotatable about the axis O. The journal bearings 9 each have a bearing main body 10 and a bearing housing 11. The bearing main body 10 has a bearing pad that slidably supports the outer circumferential surface of the rotary shaft 4 via an oil film. The bearing main body has a pivot that swingably supports the bearing pad from an outer circumferential side. The bearing housing 11 supports the bearing main body 10 on an inner circumferential side such that the rotary shaft 4 is surrounded from the outer circumferential side. The bearing housing 11 has an inner circumferential surface to which the pivot is fixed, and supports the bearing pad via the pivot. There may be another member such as a guide ring inside the bearing housing 11.

A pair of bearing stands 15 is provided such that the pair of journal bearing 9 is supported from below. The bearing stands 15 respectively support lower half portions of the corresponding journal bearings 9.

The stator 20 includes a casing 21 and a stator vane row group 22.

The casing 21 is provided to surround a part of the rotor 3 from the outer circumferential side. The rotary shaft 4 of the rotor 3 penetrates through the casing 21 in the axis O direction. Both ends of the rotary shaft 4 are positioned outside the casing 21. Both ends of the rotary shaft 4 are supported by the thrust bearing 8 and the journal bearings 9 on outer sides of the casing 21. The rotor blade row group 5 of the rotor 3 is disposed inside the casing 21.

The stator vane row group 22 is configured with a plurality of stator vane rows 23 provided on an inner circumference of the casing 21 at intervals in the axis O direction. Each of the stator vane rows 23 is configured by arranging a plurality of stator vanes 24, which extend from the inner circumferential surface of the casing 21 to a radially inner side, at intervals in the circumferential direction. That is, each of the stator vane rows 23 is configured with the plurality of stator vanes 24 radially provided at positions in the same axis O direction of the rotary shaft 4. The stator vane rows 23 are disposed alternately with the rotor blade rows 6 of the rotor 3 in the axis O direction.

In such a steam turbine 2, steam introduced in the casing 21 passes through flow passages between the stator vane rows 23 and the rotor blade rows 6. At this time, by the steam rotating the rotor blades 7, the rotary shaft 4 rotates along with the rotor blades 7, and power (rotational energy) is transmitted to a machine such as a generator connected to the rotary shaft 4.

Next, the blade abnormality detecting system 30 will be described.

As illustrated in FIG. 1, the blade abnormality detecting system 30 includes a vibration sensor 40 and a blade abnormality detecting device 50.

The vibration sensor 40 is provided in the bearing stand 15 of the steam turbine 2. Vibration generated by the rotor 3 of the steam turbine 2 is propagated to the bearing stands 15 via the bearing main bodies 10 and the bearing housings 11 of the journal bearings 9. The vibration sensor 40 detects the vibration propagated in this manner. An acceleration sensor is adopted as the vibration sensor 40 in the embodiment.

For example, a piezoelectric sensor is adopted as an acceleration sensor. The piezoelectric sensor is a sensor that uses a piezoelectric effect. When acceleration is applied to the piezoelectric sensor, a charge is generated according to stress of that time. The charge generated in this manner becomes an output of the acceleration sensor. Vibration of the rotor blade rows 6 of the rotor 3 is propagated to the bearing stands 15. The vibration is detected by the acceleration sensor as acceleration and is output to the blade abnormality detecting device 50.

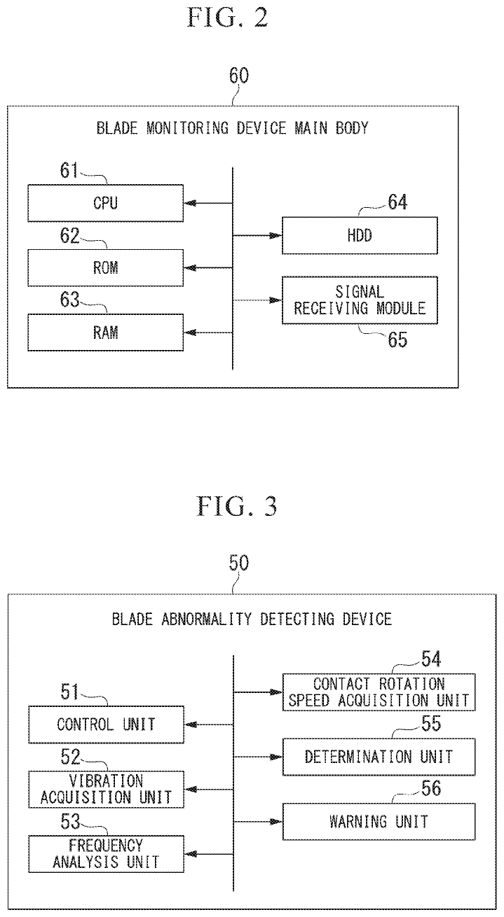

As shown in FIG. 2, the blade abnormality detecting device 50 is a computer including a central processing unit (CPU) 61, a read only memory (ROM) 62, a random access memory (RAM) 63, a hard disk drive (HDD) 64, and a signal receiving module 65. The signal receiving module 65 receives a signal from the acceleration sensor. The signal receiving module 65 may receive, for example, a signal of the acceleration sensor, which is amplified via a charge amplifier.

As shown in FIG. 3, the CPU 61 of the blade abnormality detecting device 50 has, by execution of a program stored in the blade abnormality detecting device in advance, a control unit 51, a vibration acquisition unit 52, a frequency analysis unit 53, a contact rotation speed acquisition unit 54, a determination unit 55, and a warning unit 56.

The control unit 51 controls other functional units included in an analysis device.

The vibration acquisition unit 52 acquires vibration (acceleration) information of the steam turbine 2 when the rotation speed of the rotor 3 changes, along with the rotation speed.

More specifically, the vibration acquisition unit 52 acquires vibration when the rotation speed increases at the time of start of the steam turbine 2 or when the rotation speed decreases at the time of stop operation of the steam turbine 2, which is obtained from the acceleration sensor, along with the rotation speed of the rotor 3. In addition, the vibration acquisition unit may acquire vibration when the rotation speed changes and information of the rotation speed, at the time of operation of the steam turbine 2.

The information of the rotation speed may be acquired from, for example, an additionally provided sensor detecting the rotation speed of the rotor 3. In addition, the vibration acquisition unit may acquire the rotation speed of the rotor 3 from operation information of the steam turbine 2.

The frequency analysis unit 53 performs frequency analysis according to an acquisition result of the vibration acquisition unit 52, and acquires natural frequency in each rotation speed of the entire rotor blade row group 5.

That is, the frequency analysis unit 53 executes frequency analysis with respect to vibration (acceleration) information in each rotation speed, which is obtained from the acceleration sensor. Accordingly, the frequency analysis unit acquires an eigenmode and natural frequency, which is frequency of that time, of the entire rotor blade row group 5 for each rotation speed. Consequently, the frequency analysis unit can acquire a relationship between natural frequency and the rotation speed in each vibration mode of the rotor blade row group 5.

The contact rotation speed acquisition unit 54 acquires the contact rotation speeds of the rotor blade rows 6 according to an analysis result of the frequency analysis unit 53. Herein, the contact rotation speed indicates a rotation speed, which serves as a boundary between a state where shrouds 7a of the neighboring rotor blades 7 are in contact with each other and a state where the shrouds are spaced apart from each other.

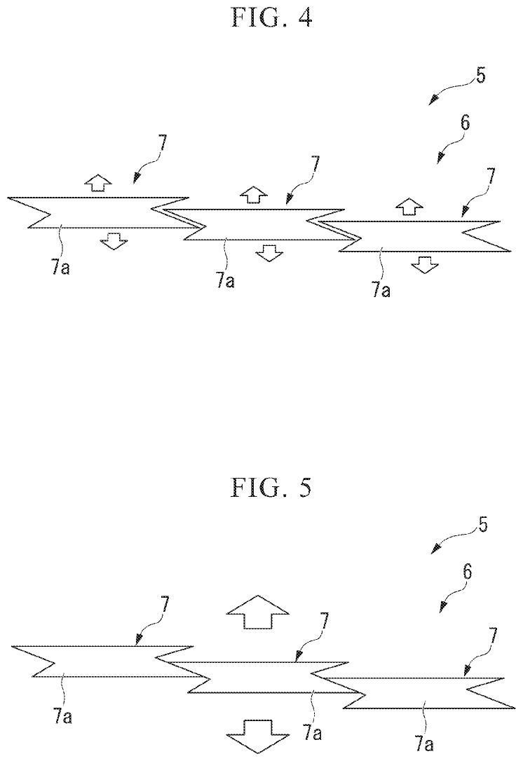

That is, in a state where the rotation speed of the rotor 3 is low, for example, as illustrated in FIG. 4, the shrouds 7a of the neighboring rotor blades 7 in the circumferential direction are in a separated state. Since each of the rotor blades 7 independently vibrates in such a state, the rotor blade rows 6 and the rotor blade row group 5 have low rigidity. For this reason, the natural frequency in each vibration mode of the rotor blade row group 5 is a relatively small value.

On the other hand, in a state where the rotation speed of the rotor 3 is high, for example, as illustrated in FIG. 5, the shrouds 7a of the neighboring rotor blades 7 in the circumferential direction are in contact with each other at a contact surface. When the rotor blade rows 6 form an annular integral structure in this manner, the rotor blade rows 6 integrally vibrate as a whole. For this reason, the entire rotor blade row group 5 configured with such rotor blade rows 6 has high rigidity, and natural frequency in each vibration mode of the rotor blade row group 5 is a relatively large value.

The contact rotation speed is a rotation speed which serves as a boundary between a state where the shrouds 7a of the rotor blades 7 are spaced apart from each other and a state where the shrouds are in contact with each other. With the contact rotation speed as the boundary, the natural frequency of each vibration mode of the rotor blade rows 6 significantly changes. For this reason, the contact rotation speed acquisition unit 54 may acquire, for example, a rotation speed when a ratio of a change in natural frequency to a change in the rotation speed is equal to or higher than a threshold determined in advance as the contact rotation speed. In addition, a Campbell diagram showing a relationship between natural frequency and the rotation speed of the rotor blade row group 5 may be prepared, the rotation speed at which natural frequency increases by one stage may be found by visual inspection or image processing, and this rotation speed may be set as the contact rotation speed.

The determination unit 55 determines whether not any one of rotor blade rows 6 of the rotor blade row group 5 is abnormal according to the contact rotation speed acquired by the contact rotation speed acquisition unit 54.

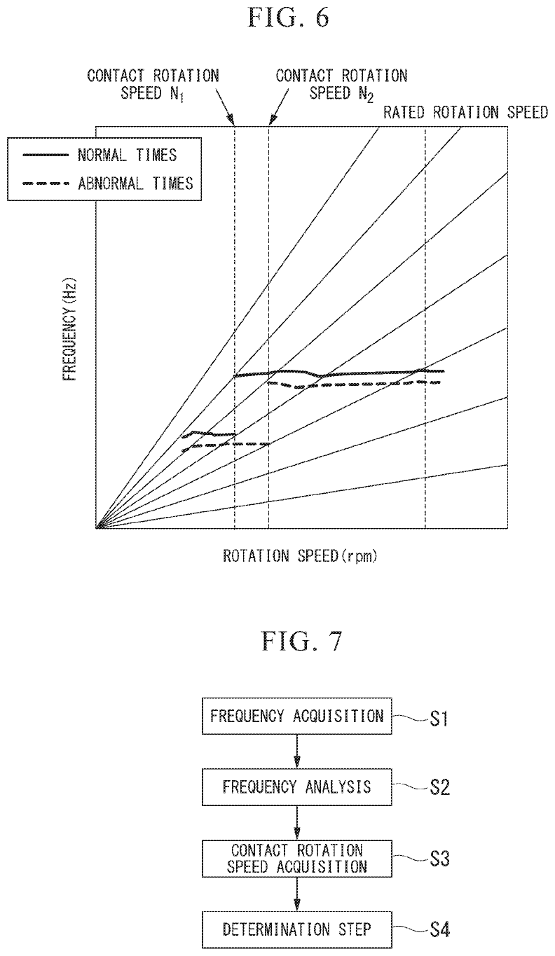

Herein, a Campbell diagram of the entire rotor blade row group 5 is shown in FIG. 6. A horizontal axis of FIG. 6 indicates the rotation speed (rpm) of the steam turbine 2, and a vertical axis indicates frequency (Hz). In addition, an oblique axis indicates a rotation degree, and the steeper the inclination of the oblique axis, the larger the rotation degree.

A solid line extending in a horizontal axis direction in FIG. 6 is natural frequency (primary mode) of the rotor blade row group 5 in normal times when an abnormality or damage has not occurred in any one of the rotor blades 7. A dashed line extending in the horizontal axis direction in FIG. 4 is natural frequency (primary mode) of the rotor blade row group 5 in abnormal times when an abnormality or damage has occurred in any one of the rotor blades 7. Although only the natural frequency in the primary mode is shown in FIG. 6, the same behavior as the line in the primary mode is shown even in secondary, tertiary, and even higher modes.

Herein, as one form of an abnormality in the rotor blades 7, the contact surface is scraped in some cases due to friction caused by slight vibration between the shrouds 7a. As a result, in a case where a gap between the neighboring shrouds 7a is wide, the contact rotation speeds of the rotor blades 7 are high compared to a normal state. Therefore, as natural frequency at the time of a rotation increase is observed, a contact rotation speed between the shrouds 7a increases in an abnormal state caused by the shrouds 7a being scraped, compared to normal times.

For this reason, as shown in FIG. 6, a contact rotation speed N2 in abnormal times shows a large value compared to a contact rotation speed N1 in normal times. Even when an abnormality has occurred in some of the rotor blades 7 of the rotor blade rows 6, out of the plurality of rotor blade row groups 5, the contact rotation speed of the entire rotor blade row group 5 declines.

Based on the knowledge, the determination unit 55 determines whether or not the contact rotation speed (the contact rotation speed according to a vibration measured value) acquired by the contact rotation speed acquisition unit 54 is abnormal by comparing with the contact rotation speed N1 in normal times. Specifically, for example, in a case where the contact rotation speed acquired by the contact rotation speed acquisition unit 54 is different from the contact rotation speed N1 by a predetermined threshold or more, it may be determined that there is an abnormality. In addition, in a case where the contact rotation speed is equal to or larger than a threshold determined in advance (a value larger than the contact rotation speed N1 in normal times), it may be determined that there is an abnormality.

The warning unit 56 outputs a warning according to a determination result of the determination unit 55. That is, in a case where the determination unit 55 determines that there is an abnormality, the warning unit 56 performs processing of outputting a warning. The warning unit 56 may perform processing of displaying warning information onto a monitor, or may perform processing of sounding a warning as an alarm.

Next, a blade abnormality detecting method according to the embodiment will be described with reference to a flowchart shown in FIG. 7. The blade abnormality detecting method includes a vibration acquisition step S1, a frequency analysis step S2, a contact rotation speed acquisition step S3, and a determination step S4.

In the vibration acquisition step S1, as in the processing performed by the vibration acquisition unit 52, the vibration of the steam turbine 2 when the rotation speed of the rotor 3 changes is acquired, along with the rotation speed.

After the vibration acquisition step S1, the frequency analysis step S2 is performed. In the frequency analysis step S2, as in the processing performed by the frequency analysis unit 53, frequency analysis is performed according to an acquisition result of the vibration acquisition unit 52, and natural frequency in each rotation speed of the entire rotor blade row group 5 is acquired. Consequently, a relationship between natural frequency and the rotation speed of the entire rotor blade row group 5 can be acquired.

After the frequency analysis step S2, the contact rotation speed acquisition step S3 is performed. In the contact rotation speed acquisition step S3, as in the processing by the contact rotation speed acquisition unit 54, the contact rotation speeds of the rotor blade rows 6 are acquired according to an analysis result of the frequency analysis unit 53.

After the frequency analysis step S2, the determination step S4 is performed. In the determination step S4, as in the processing by the determination unit 55, whether or not any one of rotor blade rows 6 of the rotor blade row group 5 is abnormal is determined according to the contact rotation speed acquired by the contact rotation speed acquisition unit 54.

As described above, in the steam turbine system 1 according to the embodiment, whether an abnormality has occurred in any one of the rotor blades 7 of the rotor blade rows 6 in the rotor blade row group 5 can be easily learned by determining whether or not the rotor blade row groups are abnormal with the contact rotation speed acquired according to a vibration measured value as an indicator.

In the aspect, by the frequency analysis unit 53 performing frequency analysis according to actual vibration of the rotary machine and the rotation speed, which are acquired by the vibration acquisition unit 52, the natural frequency of the rotor blade rows 6 in each rotation speed is acquired. The contact rotation speed acquisition unit 54 acquires a rotation speed at which the natural frequency of the rotor blades 7 changes to, for example, a value that is equal to or higher than a threshold, as the contact rotation speed.

Herein, as described above, the contact rotation speed increases in abnormal times when the shrouds 7a are scraped, compared to normal times. Based on the knowledge, the contact rotation speed acquisition unit 54 determines whether or not the rotor blade rows 6 are abnormal, that is, whether or not an abnormality has occurred in the rotor blades 7 included in the rotor blade rows 6 according to the contact rotation speed. Accordingly, abnormality in the rotor blade rows 6 can be easily detected.

In addition, the acceleration sensor provided in the bearing stand 15 is adopted in the embodiment as the vibration sensor 40 that detects the vibration of the steam turbine 2. Therefore, an abnormality in the rotor blades 7 can be stably detected regardless of properties of steam, which is a working fluid of the steam turbine 2.

Although the embodiment of the present invention is described hereinbefore, the present invention is not limited thereto, and various modifications can be made without departing from the technical spirit of the invention.

For example, although an example in which the acceleration sensor provided in the bearing stand 15 is adopted as the vibration sensor 40 is described in the embodiment, another configuration may be adopted as the vibration sensor 40. For example, a displacement sensor that detects the displacement of the rotary shaft 4 from the outside of the steam turbine 2 may be provided, and displacement information of the rotary shaft 4, which is detected by the displacement sensor, may be output as vibration information to the blade abnormality detecting device 50. Accordingly, as in the embodiment, an abnormality in the rotor blade rows 6 can be easily detected.

Although an example in which the present invention is applied to the steam turbine 2 is described in the embodiment, the invention may be applied to another rotary machine, for example, a gas turbine.

### INDUSTRIAL APPLICABILITY

In the blade abnormality detecting device, the blade abnormality detecting system, the rotary machine system, and the blade abnormality detecting method of the present invention, an abnormality in the rotor blades can be easily detected.

### REFERENCE SIGNS LIST

1: steam turbine system
2: steam turbine
3: rotor
4: rotary shaft
5: rotor blade row group
6: rotor blade row
7: rotor blade
7a: shroud
8: thrust bearing
9: journal bearing
10: bearing main body
11: bearing housing
15: bearing stand
20: stator
21: casing
22: stator vane row group
23: stator vane row
24: stator vane
30: blade abnormality detecting system
40: vibration sensor
50: blade abnormality detecting device
51: control unit
52: vibration acquisition unit
53: frequency analysis unit
54: contact rotation speed acquisition unit
55: determination unit
56: warning unit
61: CPU
62: ROM
63: RAM
64: HDD
65: signal receiving module
S1: vibration acquisition step
S2: frequency analysis step
S3: contact rotation speed acquisition step
S4: determination step
O: axis

1. A blade abnormality detecting device of a rotary machine including a rotor that has a rotary shaft that is configured to rotate about an axis and a rotor blade row formed of a plurality of rotor blades, which radially extend from the rotary shaft and have shrouds on tips, the device comprising:
a vibration acquisition unit that is configured to acquire vibration of the rotary machine when a rotation speed of the rotor changes, along with the rotation speed;
a frequency analysis unit that is configured to perform frequency analysis according to an acquisition result of the vibration acquisition unit, and acquire natural frequency in each rotation speed of the rotor blade row;
a contact rotation speed acquisition unit that is configured to acquire a contact rotation speed, which serves as a boundary between a state where the shrouds of the neighboring rotor blades are in contact with each other and a state where the shrouds of the neighboring rotor blades are spaced apart from each other, according to an analysis result of the frequency analysis unit; and
a determination unit that determines whether or not the rotor blade row is abnormal according to the contact rotation speed acquired by the contact rotation speed acquisition unit.

2. A blade abnormality detecting system comprising:
the blade abnormality detecting device according to claim 1; and
a vibration sensor that is provided in the rotary machine and is configured to detect vibration of the rotary machine.

3. The blade abnormality detecting system according to claim 2,
wherein the rotary machine has a bearing that supports the rotary shaft to be rotatable about the axis and a bearing stand that supports the bearing, and
the vibration sensor is an acceleration sensor provided in the bearing stand.

4. A rotary machine system comprising:
the rotary machine; and
the blade abnormality detecting system according to claim 2.

5. A blade abnormality detecting method of a rotary machine including a rotor that has a rotary shaft that is configured to rotate about an axis and a rotor blade row having a plurality of rotor blades, which radially extend from the rotary shaft, the method comprising:
a vibration acquisition step of acquiring vibration of the rotary machine along with a rotation speed of the rotor while changing the rotation speed;
a frequency analysis step of performing frequency analysis according to an acquisition result of the vibration acquisition step and acquiring a relationship between the rotation speed and frequency;
a contact rotation speed acquisition step of acquiring a contact rotation speed, which serves as a boundary between a state where shrouds of the neighboring rotor blades are in contact with each other and a state where the shrouds of the neighboring rotor blades are spaced apart from each other, according to an analysis result of the frequency analysis step; and
a determination step of determining whether or not the rotor blade row is abnormal according to the contact rotation speed acquired in the contact rotation speed acquisition step.
